(19) United States
(12) Patent Application Publication
(10) Pub. No.: US 2008/0054171 A1
(43) Pub. Date: Mar. 6, 2008

(54) Target for Laser Desorption/Ionisation Mass Spectrometry

(75) Inventors: Gunther Bonn, Zirl (AT); Isabel Feuerstein, Innsbruck (AT); Christian Wolfgang Huck, Innsbruck (AT); Muhammad Najam-Al-Haq, Innsbruck (AT); Matthias Rainer, Grinzens (AT); Gunther Stecher, Natters (AT); Georg Schwarzmann, Zirl (AT); Doris Steinmuller-Nethl, Rinn/Aldrans (AT); Detlef Steinmuller, Rinn/Aldrans (AT)

Correspondence Address: LERNER GREENBERG STEMER LLP, P O BOX 2480, HOLLYWOOD, FL, 33022-2480, US

(73) Assignees: Physikalisches Buro Steinmuller GmbH; Gunther Bonn

(21) Appl. No.: 11/547,411

(22) PCT Filed: Apr. 4, 2004
(86) PCT No.: PCT/EP05/51496

§ 371 Date: Jan. 22, 2007

(30) Foreign Application Priority Data
Apr. 2, 2004 (AT) A 589/2004

(51) Int. Cl. G21K 5/04

(52) U.S. Cl. 250/282; 250/288

(57) ABSTRACT

The invention relates to a target for a laser desorption/ionisation mass spectrometer, comprising a substrate that is at least partially coated with a carbon-containing layer comprising a material selected from the group consisting of diamond, amorphous carbon, DLC (diamond-like carbon), graphite, nanotubes, nanowires, fullerenes and mixtures thereof.

For three decades lasers have been used in mass spectrometry with the aim of achieving direct desorption of intact molecular ions from condensed phases by suitable primary excitation. In the initial experiments, samples were applied in a thin layer to an electrically conductive sample holder and subsequently irradiated with a pulsed laser. A further development which resulted in embedding the samples to be investigated in a matrix consisting of small organic molecules eventually made it possible to analyze relatively large biomolecules (>1 kDa) first and foremost peptides and proteins, successfully and without generating a non-analyzable number of fragments. This method is known as matrix-assisted laser desorption/ionization mass spectrometry (MALDI-MS) and, in a further development, as surface enhanced laser desorption/ionization mass spectrometry (SELDI-MS). A detailed description of the principles of both technologies can be found, for example, in “Massenspektrometrie in der Biochemie” [Mass spectrometry in biochemistry] (W. D. Lehmann, Spektrum Akademischer Verlag, 1996, ISBN 3-86025-094-9), in “Matrix Assisted Laser Desorption/Ionization: A New Approach to Mass Spectrometry of Large Biomolecules” (Biological Mass Spectrometry, Burlingame and McCloskey, editors, Elsevier Science Publishers, Amsterdam, pp. 49-60, 1990) and in EP 0 700 521 B1.

MALDI/SELDI-MS involves applying a substance to be analyzed and a “matrix” in which the analytical substance has been embedded to a “target” (i.e. a sample support or sample holder) and subsequently activated by a laser beam. The laser energy, with respect to its wavelength and intensity, matches the matrix so that the latter is vaporized and, in the process, pulls the ideally undamaged biological substances off the surface of the target. In the course of this activation, the biological sample is ionized and thereby can be accelerated via electric fields and be analyzed, for example as a function of the time of flight of the molecules, which in turn is proportional to the square root of the molecular mass.

Various demands are made on the target: firstly, it must be electrically conductive in order to enable an even distribution of the electric field; secondly, the surface properties of the target may not alter or destroy the sample, this being very important especially in the case of biomolecules such as DNA, proteins or peptides, for example.

Various embodiments have been proposed in the course of the development of such targets. For example, U.S. Pat. No. 5,859,431 A discloses targets for use in MALDI-TOF analyses. The targets described therein have both smooth and macroscopically visible rough surfaces. The resulting interfaces between rough and smooth areas firstly restrict the sample fluid to a defined area and secondly makes the dried sample more visible. According to said application, the target consists of a suitable conductive material, preferably stainless steel.

CA 2 371 738 A1 discloses targets whose surface is coated with a hydrophobic material (for example a polymer), in order to arrest the sample drops in the hydrophilic recesses provided. The surface or the polymer must either be or be rendered electrically conductive in order to reduce the surface charge of the target and improve the resolution of mass-spectrometric analysis.

US 2003/218130 A1 comprises binding monomers covalently to a substrate and, in a further step, binding a polysaccharide-based hydrogel to said monomers. Subsequent functionalization of said hydrogel with functional groups also employed in chromatography enables substances to be selectively bound and analyzed. According to this US publication, targets of this kind are therefore preferably used in SELDI-MS. The disadvantages of this technology are low sensitivity and a lack of reusability of the targets and biochips, respectively.

DE 196 18 032 A1 discloses a sample support for use in a MALDI-MS device, providing a matrix substance applied to a sample support surface in order to improve stability with respect to dispatch and storage. A pre-prepared surface layer of this kind consists of a matrix substance comprising at least two components, a first component being used for ionizing the analyte molecules and another component being used for tightly surrounding the first component in order to produce a coating film providing sufficient protection from storage and transport.

DE 100 43 042 A1 discloses a sample support which may be used for MALDI measurement analyses and which has hydrophilic and hydrophobic regions separated by means of a coating. A sample support of this kind is coated with a hydrophobic layer which has ring-shaped affinity regions distributed on the surface which in turn enclose “hydrophilic anchor regions” to which a sample drop can be bound after application to said support. The affinity regions here may have hydrocarbon chains of 4-18 carbon atoms in length, and these alkane chains may be bound directly to the metal surface, for example via sulfur bridges.

DE 102 30 328 A1 describes a MALDI sample support whose surface has a plastic coating which contains specifically chemically functionalized groups such as affinity sorbents, C18 or ion exchangers.

U.S. Pat. No. 4,992,661 A discloses a process for neutralizing a voltage-charged surface of a sample support used in a scanning ion microprobe mass analyzer. The sample support here may be coated with a thin film in order to render the sample support electrically conductive.

U.S. Pat. No. 5,958,345 A discloses a substrate which allows a substance, in particular a liquid substance, to be locally concentrated by providing firstly for constructive measures and secondly for different surface properties of the particular regions. This involves a hydrophilic inner region being enclosed by a hydrophobic outer region, thereby enabling a liquid to be collected in the form of drops in said inner region, resulting in a local concentration. It was thus the object of U.S. Pat. No. 5,958,345 A to make available a sample holder which allows a drop of liquid to be placed on said sample holder and to restrict the movability of the former accordingly. The surface is intended here to have both hydrophobic and hydrophilic regions.

U.S. Pat. No. 6,624,409 B discloses a substrate for MALDI-MS, which has a coating of nitride compounds, in particular of titanium nitride, zirconium nitride and hafnium nitride. Such a coating is reported to have advantages regarding sample surface inertia but nevertheless enable the voltage on the surface to be discharged. Here, metal nitrides are primarily used for coating, it also being possible to use carbon-containing nitride compounds.

EP 297 548 B1 describes a sample holder for glow discharge mass spectrometry, which may have an i-carbon or crystalline diamond coating. The diamond coating is used here for electrically insulating certain regions of the cone. A target of this kind would not be suitable for laser desorption/ionization mass spectrometry, since an LDI-MS target must be electrically conductive.

EP 1 274 116 A2 discloses a sample holder for analyzing samples by MALDI-MS, whose surface has a resistance of less than 2000Ω. The conductivity of the sample holder is obtained by using metallic sample holders or by adding carbon particles, carbon fiber, metal-coated glass beads, metal particles and combinations thereof to non-conducting materials such as plastic which are thereby rendered electrically conductive.

It is the object of the present invention to provide targets for use in mass spectrometry which are robust, easy to prepare and apply and highly biocompatible and whose surface can readily and easily be functionalized.

Accordingly, the present invention relates to a mass spectrometric target for a laser desorption/ionization mass spectrometer, comprising a substrate which is at least partially coated with a pure and/or chemo-physically modified carbon-containing layer comprising a material selected from the group consisting of diamond, amorphous carbon, DLC (diamond-like carbon), graphite, nanotubes, nanowires, fullerenes and mixtures thereof. In contrast to the mass spectrometric targets known in the prior art, the advantages of the targets of the invention are their high reproducibility, high biocompatibility, higher sensitivity and regenerability which enables them to be reused several times. Furthermore, carbon-containing layers, in particular those comprising diamonds can very easily be modified, both chemically and physically. The multiplicity of possible chemical modifications enables, for example, one or more analytes to be specifically bound to the carbon-containing layer of a target. According to the invention, the substrate may be coated completely or only partially with a carbon-containing layer. This makes it possible to prepare regions of the carbon-containing layer which have different surface properties in order to enable a multiplicity of chemical reactions on only a single target.

According to the present invention, a “target” consists of a substrate and a carbon-containing layer. The sample to be analyzed is applied to the target which serves as target for the ionizing rays in a mass spectrometer, in particular in a laser desorption/ionization mass spectrometer. The target may itself comprise all of that material of which the carbon-containing layer is composed.

The “substrate” serves as support material for the carbon-containing layer. The substrate may consist of any material which is suitable as a support for carbon-containing layers. It is possible here to use any substrates used in mass spectrometry and known in the prior art. According to the invention, substrates furthermore relate to both electrically conductive and electrically nonconductive substrates which may, where appropriate, be rendered conductive by an aftertreatment such as, for example, doping. When electrically non-conducting substrates are used, then at least the carbon-containing layer must conduct current.

According to the present invention, the carbon-containing layer comprises diamond, amorphous carbon, DLC (diamond-like-carbon), graphite, nanotubes, nanowires, fullerenes and mixtures thereof. According to the invention, any type of layers containing carbon may be used for preparing mass-spectrometric targets. It is also possible to use layers containing carbon in an SP² and/or SP³ hybridization.

The carbon-containing layer of the target preferably comprises nanocrystalline, polycrystalline, ultrananocrystalline (Carlisle J. A. and Auciello O., Ultrananocrystalline diamond Properties and Applications in Biomedical Devices, The Electrochemical Society Interface, 12 (1), 28-31 (2003)) and monocrystalline diamonds. The use of diamond surfaces has been particularly well suited to carry out the present invention, owing to high biocompatibility. The substrate may itself comprise diamonds or consist of a single diamond (“high-pressure high-temperature material”, HPHTi).

According to the invention, the term “biocompatibility” refers to the target and stipulates that the target does not adversely affect or destroy the samples, neither in its pure form nor in its chemically or physically modified form.

In the literature, pure diamond is known to have biocompatible properties. This is described, by way of example, in the article “DNA-Modified Nanocrystalline Diamond Thin-Films as stable, biologically active substrates” (Nature Materials, Nov. 24, 2002). Appropriate pretreatment of the diamond layer makes it possible to obtain properties which increase biocompatibility to individual substances drastically and above all permanently.

CA 2,061,302 discloses an example of a general possibility of preparing diamond layers. According to this document, a diamond layer is applied to a graphite substrate and a metal layer located thereupon, since in that case direct coating of graphite cannot produce a diamond layer of flawless quality.

It is furthermore possible to apply carbon-containing layers, in particular diamond layers, by means of electroplating to a substrate.

Further methods of preparation can be divided into three major categories: “hot filament processes”, “plasma processes” and “hybrid processes”. There exist furthermore also alternative technologies whose application, however, is currently not well established. An overview of various technologies can be found in “Diamond Films Handbook” (edited by Jes Asmussen and D. K. Reinhard, Marcel Dekker, 2002, ISBN 0-8247-9577-6) and in “Synthetic Diamond—Emerging CVD Science and Technology” (edited by K. E. Spear and J. P. Dismukes, The Electrochemical Society Series, John Wiley & Sons, 1994, ISBN 0-471-53589-3).

The hot filament process is based on thermal excitation of carbon-containing gases under low pressure. Here, various forms of carbon-containing layers are deposited on a substrate. Thermal excitation of a second gas—usually hydrogen which is cracked to give atomic hydrogen—then removed by etching those components in which carbon is in sp or sp² hybridization. By choosing suitable parameters it is thus possible to apply carbon-containing layers with a very high proportion of crystalline sp³ hybrid. An embodiment of this technology is described in “Diamond and Related Materials” (P. K. Bachmann et al., 1991) and in JP 2 092 895.

The plasma process involves exciting the gases by plasma excitation in a large variety of embodiments. The technology again is based on the above-described principle of depositing a large variety of carbon modifications which in turn are etched by the excited atomic hydrogen or other auxiliary gases such as, for example, argon so that, as net balance, a high proportion of sp³-hybridized crystalline diamonds is produced. Examples of this technology can be found in JP 1 157 498 and in EP 0 376 694.

The hybrid processes make use of a combination of the two above-described technologies, i.e. thermal excitation by filaments is supported by various types of plasma excitations. An embodiment is described in U.S. Pat. No. 4,504,519.

Of the alternative technologies, mention must be made of the arc-jet process in which ignition of an arc enables diamond layers—usually, however, with a high proportion of sp²—to be deposited in a spatially very limited area, usually at a high rate. An example of the technology can be found in EP 0 607 987.

AT 399 726 B describes another preferred method of preparation which is a modified hot filament process in which the gases can be excited with very high efficiency. This process can be used to prepare not only DLC layers but also nanocrystalline diamond layers which have proved to be particularly advantageous in target coating described herein.

According to the invention, the proportion of crystallite in the diamond layer can vary. The proportion of crystallite in the diamond layer is preferably at least 10%, at least 20%, at least 30%, at least 40%, at least 50%, at least 60%, at least 70%, at least 80%, at least 90%, at least 95%, at least 99%, in particular at least 99.5%. The properties of the invention were detected even at a crystallite proportion of 10%. Suitable for preparing the targets are therefore not only diamond layers with a high proportion of crystallite but also those with a low proportion of crystallite. As a result, it is also possible to use diamond-like carbon layers (DLC, diamond-like carbon) for substrate coating.

According to the invention, it is beneficial for the diamond layer to have a crystallite size of less than 500 nm, preferably less than 300 nm, in particular less than 100 nm. These crystallite sizes are particularly advantageous in the preparation of mass spectrometric targets. Other crystallite sizes may also be used according to the invention.

In a preferred embodiment, the diamond layer has a crystallite size of 0.1 nm to 500 nm, preferably from 5 to 100 nm, in particular from 8 to 30 nm.

According to the present invention, the diamond layer advantageously has a layer thickness of from 0.1 nm to 50 μm, preferably 100 nm to 40 μm, in particular from 1 to 20 μm. According to the invention, the diamond layer may have different thicknesses and may be designed in a closed or unclosed form, in order to achieve nevertheless optimal results in the analysis. Therefore, low layer thicknesses in which the layer is still not closed are also quite feasible in order to reduce the costs.

In order to achieve an even distribution of the electric field, the target as a whole is required to be electrically conductive. This may be realized according to the invention by an electrically conductive substrate and/or by an electrically conductive carbon-containing layer. Said conductivity is preferably achieved using an electrically conductive substrate. Depending on their composition, carbon-containing layers have relatively little conductivity. It is therefore advantageous in connection with the present invention for at least the substrate to be able to conduct electric current. An embodiment in which the carbon-containing layer is rendered conductive by doping (bulk and surface) and in which the substrate is nonconductive is also possible.

According to a preferred embodiment, the carbon-containing layer is conductive by virtue of doping. This involves the volume material or the surface of the carbon-containing layer with elements known in the prior art, such as boron and bromine, for example. Doping may be carried out firstly in situ by adding suitable gases, liquids or solids. Secondly, it is possible to carry out doping subsequently, with ion implanting being one possible technology for this. Examples of doped diamond layers of this kind can be found in “Thin Film Diamond” (edited by A. Lettington and J. W. Steeds, III. Royal Society (GB), 1994, ISBN 0412496305).

According to a further preferred embodiment, the carbon-containing layer on the target is conductive by virtue of adsorbed substances. For example, adsorption of hydrogen renders the surface of diamond conductive. (Oliver A. Williams and Richard B. Jackman, Surface conductivity on hydrogen terminated diamond, Semicond. Sci. Technol. 18, 34-40, (2003)).

The substrate preferably comprises graphite, metal, metal oxides, mineral oxides, semiconductors, polymer, plastic, ceramics, glass, quartz glass, silica gel, steel, composite materials, nanotubes, nanowires, fullerenes and mixtures thereof. The present invention includes not only electrically conductive substrates but also those substrates which may be rendered conductive by a treatment such as doping, for example.

The carbon-containing layer preferably has both hydrophilic and hydrophobic regions. The target here may be designed, for example, in such a way that the hydrophilic regions to which the sample solution is applied are bounded by hydrophobic regions. This enables the sample solution to be applied to the target in a targeted manner, without the sample dissolving on the target surface. CA 2 371 738 A1 describes a similar embodiment, albeit for a completely different purpose, in which the surface of the target has various surface tensions. Hydrophobic and hydrophilic regions are prepared on the diamond surface according to the methods disclosed in the prior art (US 2002/045270 A1). On the other hand, it is possible, by labeling and standardized photolithographic techniques, to structure different regions of a diamond layer by means of targeted surface modification to give hydrophobic and hydrophilic regions. This is achieved, for example, by targeted exchange of the atoms at the “dangling bonds” of the surface (see Hartl A. et al. (2004), Nature Materials 3:736-742). Other technologies of surface modification are conceivable, for example by exchanging individual atoms on the surface by means of AFM (atomic force microscopy).

According to a preferred embodiment, the carbon-containing layer on the surface of the substrate has been modified chemo-physically. A chemical modification of the invention may alter the surface so as for further substances to be able to bind specifically or selectively to said surface, for example.

According to a further preferred embodiment, the chemo-physically modified carbon-containing layer has at least one binding functionality selected from the group consisting of polar groups, apolar groups, ionic groups, groups having affinity, specific groups, metal-complexing groups and mixtures thereof. It is possible here to use, for example, any functional groups used in chromatography and contributing to binding.

“Binding functionality” denotes for the purposes of the present invention a functional group which may bind molecules (analytes) either covalently or noncovalently.

According to the invention, groups “having affinity” include any functional groups having an affinity to other chemical compounds and groups (e.g. to phosphorylated compounds).

“Specific” functional groups comprise any chemical compounds capable of binding other chemical compounds and groups specifically. Examples which may be mentioned are in this connection antibody-antigen, enzyme-substrate, enzyme-inhibitor and protein-ligand compounds.

The carbon-containing layer is preferably covalently modified with hydrogen (—H) (Toshiki Tsubota, Osamu Hirabayashi, Shintaro Ida, Shoji Nagaoka, Masanori Nagata and Yasumichi Matsumoto, Reactivity of the hydrogen atoms on diamond surface with various radical initiators in mild condition, Diamond and Related materials, 11 (7) 1360-1365 (2002)), halogens (—Cl, —Br, —I, —F), hydroxyl functions (—OH), carbonyl functions (═O), aromatic ring systems, sulfur and sulfur derivatives, Grignard compounds (—MgBr), amines (—NH₂), epoxides, metals (e.g. —Li) or carbon chains. The chemo-physically modified carbon-containing layer has, where appropriate, binding functionalities.

According to a preferred embodiment, the carbon-containing layer has at least one binding functionality selected from the group consisting of carbon bonds, epoxides, halogens, amino groups, hydroxy groups, acid groups, acid chlorides, cyanide groups, aldehyde groups, sulfate groups, sulfonate groups, phosphate groups, metal-complexing groups, thioethers, biotin, thiolene and mixtures thereof. Direct application of functional groups to the carbon-containing layer on the target enables analytes such as, for example, peptides, proteins, nucleic acids and other chemical substances to bind covalently or noncovalently to said target.

According to a further preferred embodiment, the carbon-containing layer is chemically modified with one or more linkers. Here, the linker is bound to the chemo-physically modified carbon-containing layer by methods known per se in the prior art (Fox and Whitesell, Organische Chemie, 1995, pages 255, 297-298, 335-338, 367-368, 406-408, 444-446, 493-496, 525-526, 550-551, 586-587, 879-884) (for example, a compound containing a carbon double bond is bound to the diamond layer by way of photochemical reactions (Todd Strother, Tanya Knickerbocker, John N. Russel, Jr. James E. Butler, Lloyd M. Smith, Robert J. Hamers, Photochemical Functionalisation of Diamond Films, Langmuir 18 (4): 968-971 (2002)). These linkers themselves comprise functional groups which are directly contacted with a sample to be analyzed, or they comprise chemically functional groups to which other chemical compounds with functional groups are bound which are again contacted with a sample to be analyzed.

A “linker” means in accordance with the present invention a chemical compound having a functional group which binds either directly to the carbon-containing layer and/or chemo-physically modified carbon-containing layer or to the functional group of another linker.

According to the invention, a “functional group” means that part of a molecule which is responsible for binding of another molecule. These functional groups comprise, for example, any binding functionalities applied in affinity chromatography, reversed phase chromatography, normal phase chromatography or ion exchange chromatography, in order to specifically bind, for example, analytes such as antibodies, proteins, DNA, RNA, receptors and the like. According to a preferred embodiment, the linker itself has at least one binding functionality. This enables a target which has been functionalized in this way to be used without chemical binding of further substances having a binding functionality.

The chemical modifications of the invention allow the target to be functionalized so that said target can eventually bind substances selectively, comparable to affinity, reversed phase, normal phase or ion exchange columns in chromatography. Functionalization via a linker or directly to the carbon-containing layer of mass-spectrometric targets introduces according to the invention the same functional groups as the corresponding chromatographic methods. The target modified in this way here may have a single or a plurality of such functional groups, which enables the selectivity of the target to be increased or else a plurality of substances to be bound to said target. These functionalized targets according to the present invention are particularly well suited to the use in laser desorption/ionization mass spectrometry.

The linker preferably comprises an epoxide group and is preferably selected from the group consisting of glycidyl methacrylate, 3,4-epoxybutyl acrylate, 2-methyl-2-propenyl-oxiranecarboxylic ester, methyl 3-(2-methyloxiranyl)-2-propenoate, dihydro-4-(2-propenyloxy)-2(3H)-furanone, oxiranylmethyl 2-methyl-2-propenoate, tetrahydro-3-furanyl-2-propenoic ester, oxiranylmethyl-2-butenoic ester, 1-methyl-ethenyl-oxirane acetic ester, oxiranylmethyl-3-butenoic ester, (3-methyloxiranyl)methyl-2-propenoic ester, ethyl 3-oxiranyl-2-propenoate, 2-methyl-2-propenyl-oxirane carboxylic ester, 2-oxiranylethyl-2-propenoic ester, 3-(3-butenyl)oxirane carboxylic acid, allyl 2,3-epoxy-buttyric ester, 2,3-epoxypropyl-crotonic ester, tetrahydro-2-furanyl-2-propenoic ester, (2-methyloxiranyl)methyl-2-propenoic ester, 3-oxetanyl 2-methyl-2-propenoate, and mixtures thereof. These molecules may be bound, for example, to the diamond layer via the carbon double bonds present under the influence of ultraviolet radiation (Todd Strother, Tanya Knickerbocker, John N. Russel, Jr. James E. Butler, Lloyd M. Smith, Robert J. Hamers, Photochemical Functionalisation of Diamond Films, Langmuir 18 (4): 968-971 (2002)). Finally, the free epoxide group can react further with a molecule comprising a functional group.

According to a preferred embodiment, the epoxide-containing linker has been modified with a substance selected from the group consisting of iminodiacetic acid, nitrilotriacetic acid, N-carboxy-β-alanine, aspartic acid, 2-amino-2-methyl-propanedioic acid, 2-furanacetic acid, 5-ethyl-3-hydroxy-4-methyl-2(5H)-furanone, tetrahydro-4-methylene-3-furanacetic acid, aspartic acid, 2-butenedioic acid, methylene-propanedioic acid and mixtures thereof. These molecules bind or complex metal ions and may therefore be used, in a similar way as in chromatography, for analyzing biomolecules.

According to another preferred embodiment, the linker has an amino group and is advantageously selected from the group consisting of 10-undecene-1-amine, 1-amino-5-hexene, N-2-propenyl-2,2,2-trifluoroacetamide and mixtures thereof. These molecules may be bound, for example, via a carbon double bond directly to the carbon-containing layer and are preferably employed as anion exchangers, due to their positive net charge.

The linker has preferably a carboxylic acid group and is selected from the group consisting of 2-butenedioic acid, ethylenedicarboxylic acid and mixtures thereof. Since the acids mentioned have a negative net charge, targets containing such functional groups are preferably used as cation exchangers.

According to a preferred embodiment, the linker contains a halogen and is preferably selected from the group consisting of propenyl chloride, butenyl chloride, 1-bromopropene, 1-chloropropene, 2-bromopropene, 2-chloropropene, 4-chloro-1-butene, 4-chloro-2-butene, 3-chloro-1-butene, 2-methyl-1-chloro-1-propene, 1-chloro-2-butene, 1-chloro-1-butene, 2-chloro-3-methyl-2-butene, 3-chloro-2-methyl-2-butene, 4-chloro-2-pentene, 2-chloro-2-pentene, 1-chloro-1-pentene, 1-chloro-3-methyl-1-butene, 1-chloro-2-methyl-1-butene, 3-chloro-2-pentene, 5-chloro-2-pentene, 1,5-dichloro-2-pentene, 4,4-dichloro-2-methyl-1-butene, 2-chloro-5-methyl-3-hexene, 3-chloro-4-methyl-1-hexene, 2-chloro-2-methyl-3-hexene and mixtures thereof.

According to a preferred embodiment, the substrate consists of graphite and/or titanium coated with a carbon-containing layer. The use of graphite and/or titanium as substrate has proved to be particularly suitable for use in mass spectrometry.

According to a particular variant of the target of the invention, the entire target consists of the carbon-containing layer so that substrate and carbon-containing layer are combined in one (as carbon-containing material body, for example as diamond crystal (high-pressure high-temperature material; HPHT) or as graphite block).

The carbon-containing layer has preferably a matrix adsorbed or covalently bound to said layer.

The targets of the invention, in particular the carbon-containing layers of the invention, were found to make possible a mass-spectrometric examination without the additional use of a matrix. It is further also possible to adsorb or covalently bind a matrix to the carbon-containing layer itself. Such an embodiment of the present invention enables sample supports to be provided which do not need addition of any additional matrix when a sample is investigated, but it should be noted here again that the carbon-containing layers of the invention themselves may be used as matrix.

According to a preferred embodiment, the target has been applied in a replaceable manner to a holder (“substrate holder”). This embodiment of the invention enables targets to be exchanged in a flexible manner, facilitating the handling of targets. Especially in view of the fact that it is now possible to combine various functionalized targets randomly. Numerous advantages also arise in the preparation of functionalized targets, since small handy targets which can be applied in a flexible manner can be manufactured from targets with large functionalized areas. This is of course also advantageous from a sales perspective.

The target holder with the various functionalized targets is preferably placed directly into the mass spectrometer. This enables a sample to be screened by means of applying various chromatographic techniques.

The target of the invention is preferably used in matrix-assisted laser desorption/ionization mass spectrometry (MALDI-MS) or in surface-enhanced laser desorption/ionization mass spectrometry (SELDI-MS). The use of such a target has considerable advantages over the prior art, especially regarding superior analytical results, more flexible handling and designable functionalization of the target surface in relation to a multiplicity of possible chemical reactions (Fox and Whitesell, Organische Chemie [Organic chemistry], 1995, pages 255, 297-298, 335-338, 367-368, 406-408, 444-446, 493-496, 525-526, 550-551, 586-587, 879-884), biocompatibility, robustness, produceability and durability.

According to a further aspect, the invention provides a process for analyzing a sample by means of surface-enhanced laser desorption/ionization mass spectrometry (SELDI-MS), comprising
applying a sample to a target according to the invention,
optionally removing the substances not bound to the target,
optionally adding a matrix, embedding the sample in said matrix by means of evaporating a solvent, and
analyzing the sample by means of mass spectrometry.

The present invention further also relates to a process for analyzing a sample by means of matrix-assisted laser desorption/ionization mass spectrometry (MALDI-MS), comprising
applying a sample to a target according to the invention,
optionally adding a matrix, embedding the sample in said matrix by means of evaporating a solvent, and
analyzing the sample by means of mass spectrometry.

Owing to the fact that the carbon-containing layer itself can have properties of a matrix (with or without adsorption or covalent binding of a matrix to the layer), the processes of the invention do not require the additional addition of a matrix.

According to another aspect, the present invention relates to carbon-containing particles or beads comprising or consisting of a carbon-containing layer of the invention and to the use of said particles or beads for selectively binding at least one analyte of a sample and subsequently analyzing the loaded particles or beads or the analytes eluted from said particles/beads by means of matrix-assisted laser desorption/ionization mass spectrometry.

A further aspect of the present invention relates to a carbon-containing powder comprising or consisting of the carbon-containing layer material utilized according to the invention and to the use of said powder for selectively binding one or more analytes of a sample and subsequently analyzing the loaded powder by means of matrix-assisted laser desorption/ionization mass spectrometry. Both the carbon-containing particles or beads and the carbon-containing powder are particularly well suited to the use in mass spectrometry. Both forms may be used, for example, as chromatographic material, it being possible for the loaded particles or the loaded powder to be examined either directly after application to a support in a mass spectrometer or said loaded particles or said loaded powder being treated with elution buffers in order to thus elute the analytes immobilized to the carbon-containing particles, beads or powder and subsequently to analyze the eluate by means of MALDI MS.

The present invention further also relates to a paste-like mass comprising or consisting of the carbon-containing layer material utilized according to the invention and to the use of said paste for binding one or more analytes of a sample and subsequently analyzing the loaded materials or the eluate therefrom (comprising analytes eluted from the paste-like mass) by means of matrix-assisted laser desorption/ionization mass spectrometry.

According to a further aspect of the present invention, the target and powder according to the invention, the particle/bead according to the invention and the paste-like mass according to the invention may be used in laser desorption/ionization mass spectrometry without the use of MALDI matrices, with the substrates provided with a carbon-containing layer of the invention having the following properties:
The carbon-containing layer (modified or unmodified) must absorb the laser light of the MALDI mass spectrometer in order for the analyte not to be destroyed in this way due to the high-energy effect. If the energy of the photon is greater than the binding energy of an electron of the molecule to be analyzed, an electron may be liberated directly and excess energy can be absorbed by the sample. Rapid heating during the laser pulse enables the analytes to detach explosion-like from the sample surface (target) and be converted to the gaseous state (see next point).
The carbon-containing layer (modified or unmodified) must enable the solid analyte to transfer to the gaseous phase by way of desorption, i.e. sublimation, triggered by said laser light.
The carbon-containing layer (modified or unmodified) must be able to transport charge carriers in order to ionize the analyte or must enable the analyte to be ionized in some way.

The use of conventional MALDI matrices which embed the analyte and form a mixed crystal of matrix and analyte on the target (sample holder) results in the appearance of signals of matrix fragment ions, homogeneous matrix clusters, protonated matrix ions and also free radical cations of the matrix in the MALDI mass spectra, in addition to the analyte ion signals. A substantial advantage with the use of targets (sample holder) having “MALDI matrix-like” properties is not only the fact that no further matrix needs to be added to the sample, but is evident especially in the occurrence of considerably fewer, if any, matrix clusters or damage by matrix molecules.

Carbon-containing materials such as those present in the target and powder according to the invention, the particle/bead according to the invention and the paste-like mass according to the invention may possess “MALDI matrix-like” properties without chemical modifications. Thus, for example, fullerenes and nanotubes have been described in the literature for use as MALDI matrices (e.g. Michalak, L. et al. Rapid Commun. Org. Mass Spectrom. (1994), 29: 512; Songyun Xu, Analytical Chemistry (2003), 75: 6191-6195). Moreover, chemically derivatized fullerenes and modified carbon nanotubes are also known as MALDI matrix (e.g. Ugarov, M. V., Analytical Chemistry (2004), 76: 6734-6742; Shiea Jentaie, Analytical Chemistry (2003) 75: 3587-3595; Shi-fang Ren, Rapid Commun. Mass Spectrom. (2005) 19: 255-260).

Surprisingly, these “MALDI matrix-like” properties were also found for diamond, diamond powder, diamond beads and diamond particles.

Preference is given to covalently binding energy-absorbing molecules (conventional matrices or other compounds) to the surface of a target of the invention, thereby enabling the scope of use of the carbon-containing coated targets, powders, masses and particles/beads of the invention to be increased and extended. Thus it is also possible to analyze the mass peaks of relatively small compounds—with a molecular mass of below 700 dalton—which otherwise, due to the use of conventional targets, would be covered in the mass spectra because of the resulting matrix clusters. For example, UV light enables energy-absorbing compounds such as sinapic acid or 1-allyl-2-oxo-1,2-dihydro-3-pyridinecarboxylic acid to covalently bind to the nanocrystalline diamond surface of a target of the invention.

For particular applications, merely physical adsorption of matrix molecules to the surface of a target of the invention would also be sufficient, thus, for example, the analyses of compounds with molecular masses of below 700 dalton, with the observed mass range being above that in most cases.

The invention will be illustrated further by the following figures and examples but without being limited thereto.

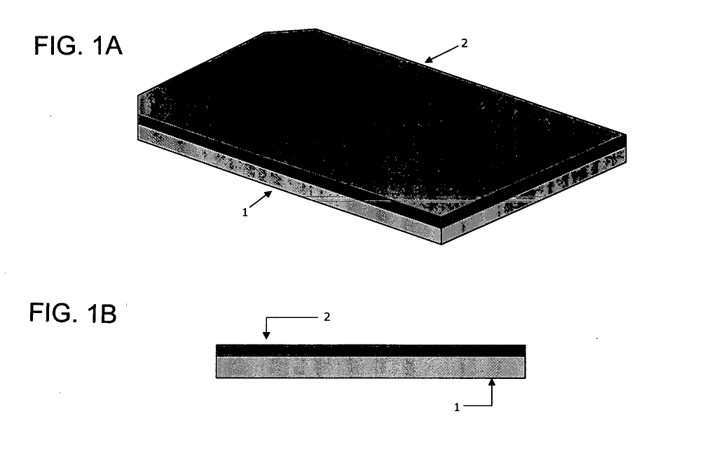

FIG. 1 depicts top view A and cross section B of a target consisting of a substrate 1 and a diamond layer 2.

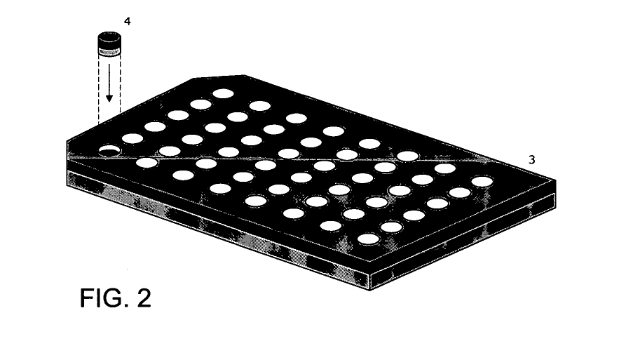

FIG. 2 depicts by way of example a target holder 3 to which exchangeable functionalized targets 4 have been applied.

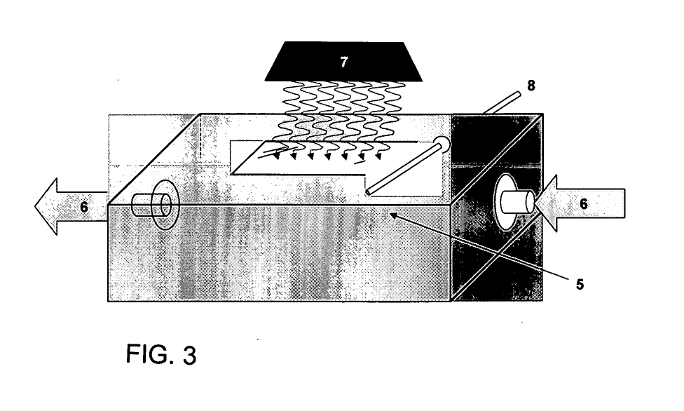

FIG. 3 depicts an illumination chamber which can be used to functionalize a target 5 with a linker (through feed line 8) by means of UV irradiation (UV lamp 7) with supply 6 of inert gas.

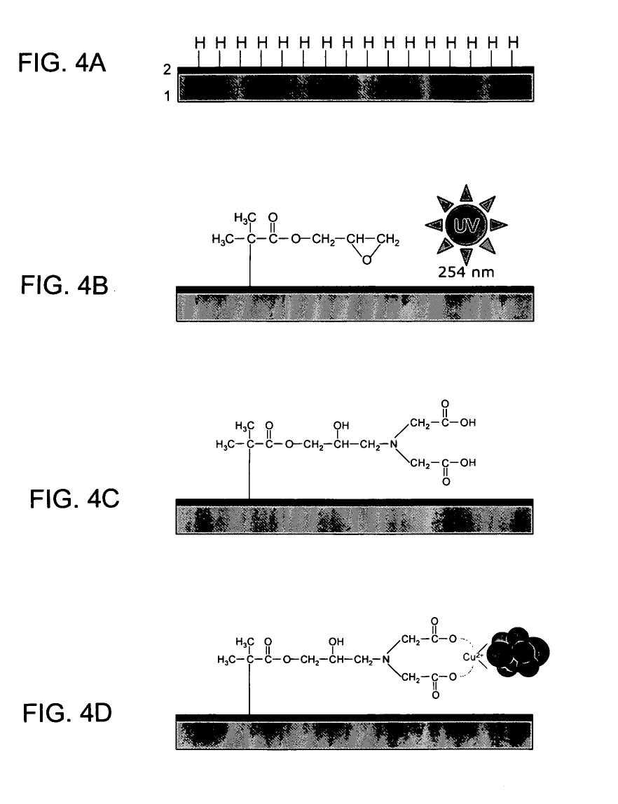

FIG. 4 depicts the preparation of a functionalized target with glycidyl methacrylate as linker and iminodiacetic acid as complexing group. Binding of the linker (e.g. glycidyl methacrylate) to a diamond layer A saturated with hydrogen is initiated by UV irradiation B. The free epoxide group of the linker eventually reacts further with iminodiacetic acid and thus forms a metal-complexing surface of C. The functionalized target is finally loaded with metal ions D.

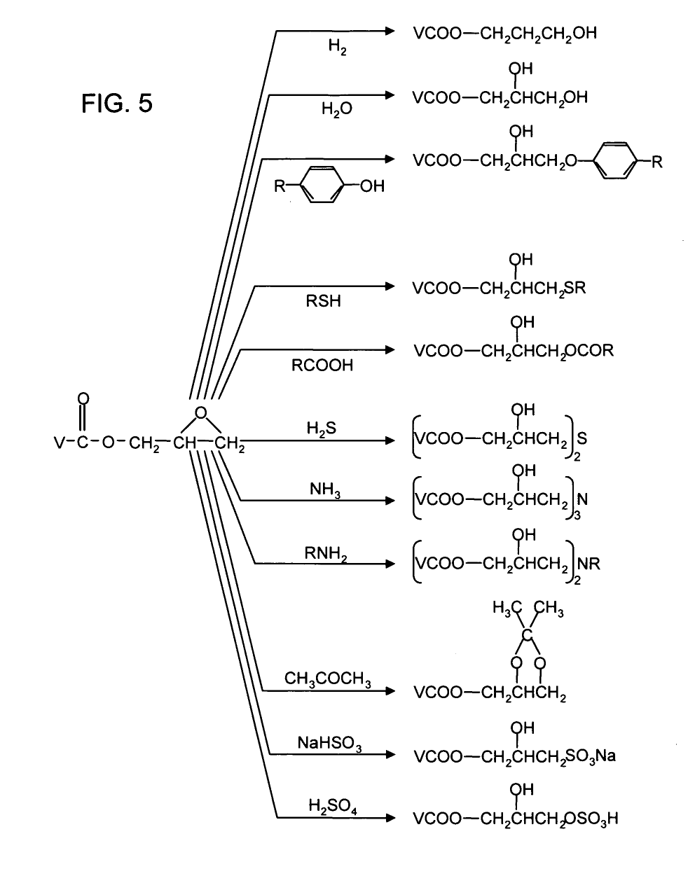

FIG. 5 depicts by way of example further functional groups which can be bound via the epoxide group of the linker to the target.

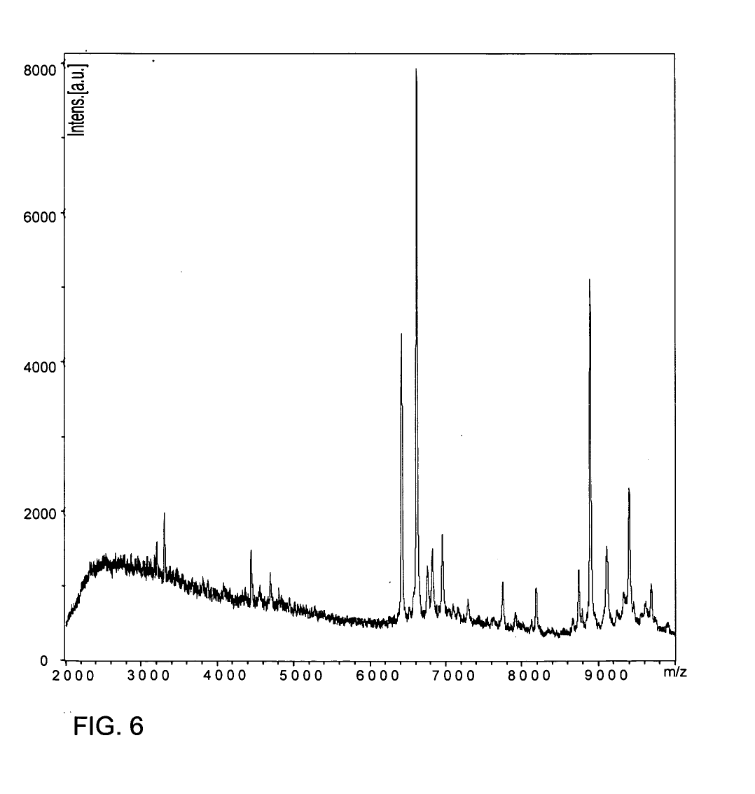

FIG. 6 depicts a mass-spectrometric analysis of human serum, carried out on a derivatized, diamond-coated target in a mass range of 2-10 kDa, applying the following conditions: sinapic acid in 50% acetonitrile and 50% 0.1% TFA in deionized water; measured in positive linear mode.

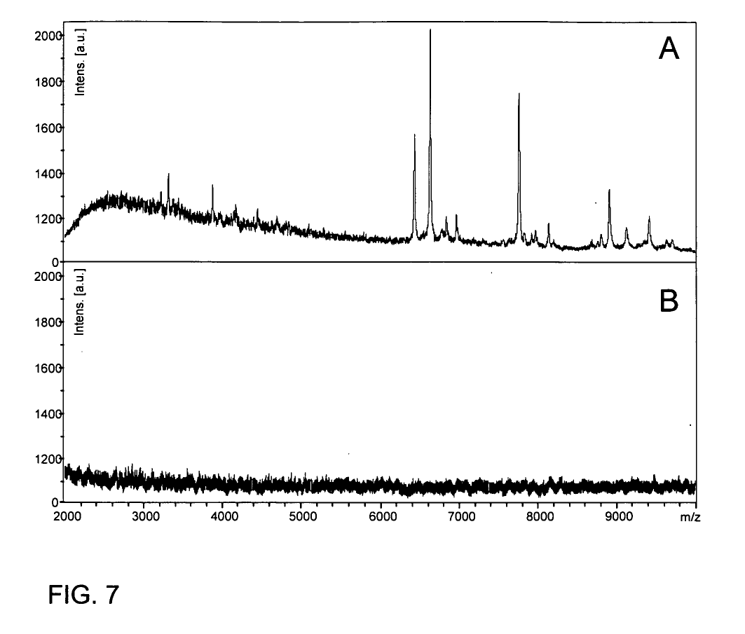

FIG. 7 depicts an MS spectrum of blood serum using a target of the invention prior to (FIG. 7A) and after (FIG. 7B) regeneration and treatment with EDTA and renewed loading with metal ions, with the following conditions having been applied: sinapic acid in 50% acetonitrile and 50% 0.1% TFA in deionized water; measured in positive linear mode; mass range from 2-10 kDa.

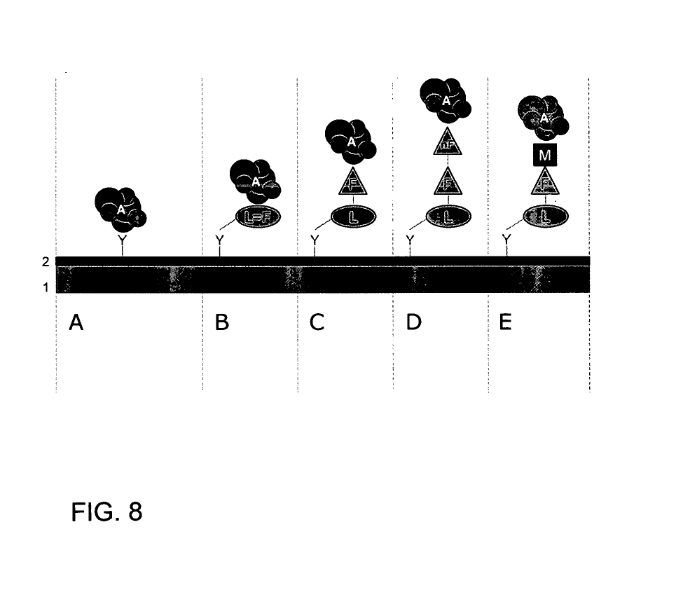

FIG. 8 depicts the various possibilities of binding an analyte to a target of the invention consisting of a substrate 1 and a carbon-containing layer 2. The analyte may be bound to the target here directly via a chemically modified target (with Y comprising, for example, H, Cl, Br, I, F, OH, O, S, NH₂, MgBr, Li, benzene; FIG. 8A), via a linker L (e.g. glycidyl methacrylate) which may also have a binding functionality (FIG. 8B), via a compound F (FIG. 8C) which is bound to a linker L and has a binding functionality or a functional group, via a plurality of compounds F and nF (FIG. 8D) or via a metal ion M (FIG. 8E). Said binding functionality allows covalent and/or noncovalent binding of the analyte to the target.

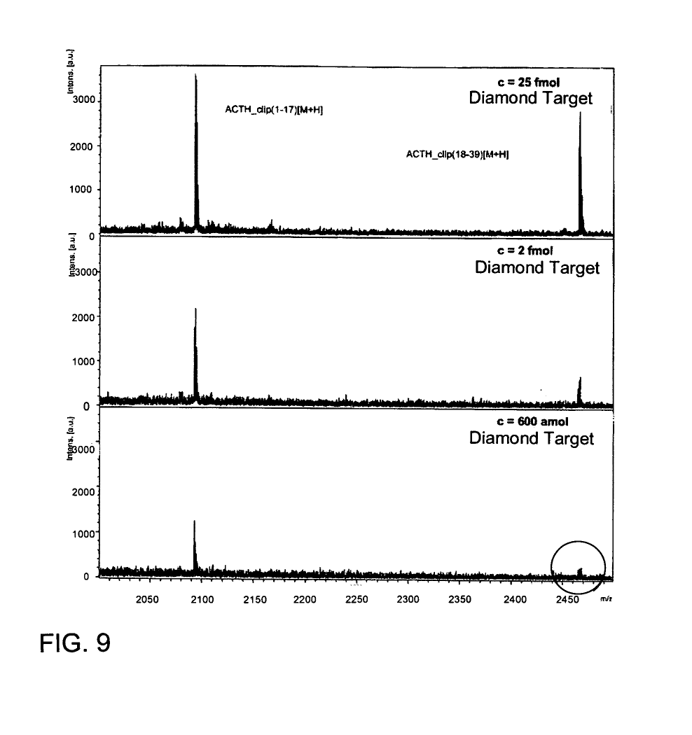

FIG. 9 depicts MS spectra of solutions containing the peptides ACTH_clip(1-17) and ACTH_clip(18-39) in a series of concentrations (50 fmol/μl, 4 fmol/μl and 1200 amol/μl) with alpha-cyano-4-hydroxycinnamic acid (HCCA) as matrix substance with a target of the invention. Please note: in each case 0.5 μl of solution were applied to the target. Since only half a microliter is applied to the target and the concentrations of the solutions refer to one microliter, the effective, analyzed absolute amount corresponds to half the concentration value.

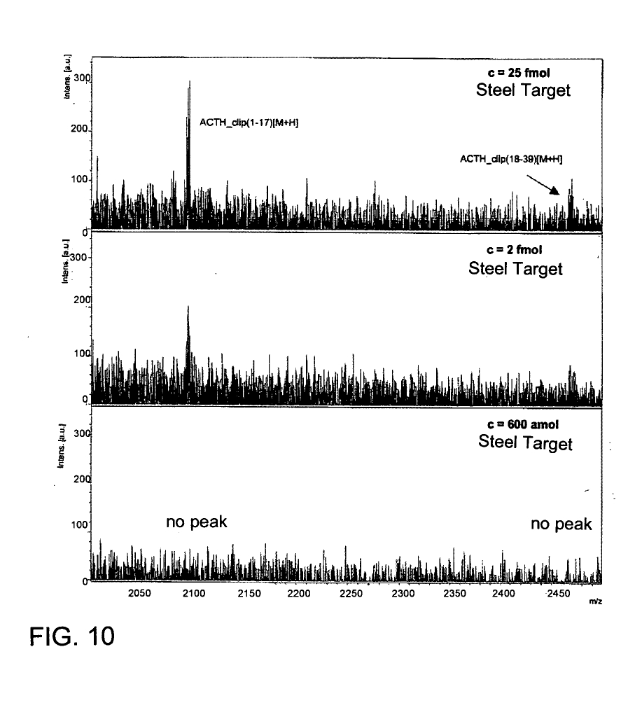

FIG. 10 depicts MS spectra of solutions containing the peptides ACTH_clip(1-17) and ACTH_clip(18-39) in a series of concentrations (50 fmol/μl, 4 fmol/μl and 1200 amol/μl) with alpha-cyano-4-hydroxycinnamic acid (HCCA) as matrix substance with a conventional steel target.

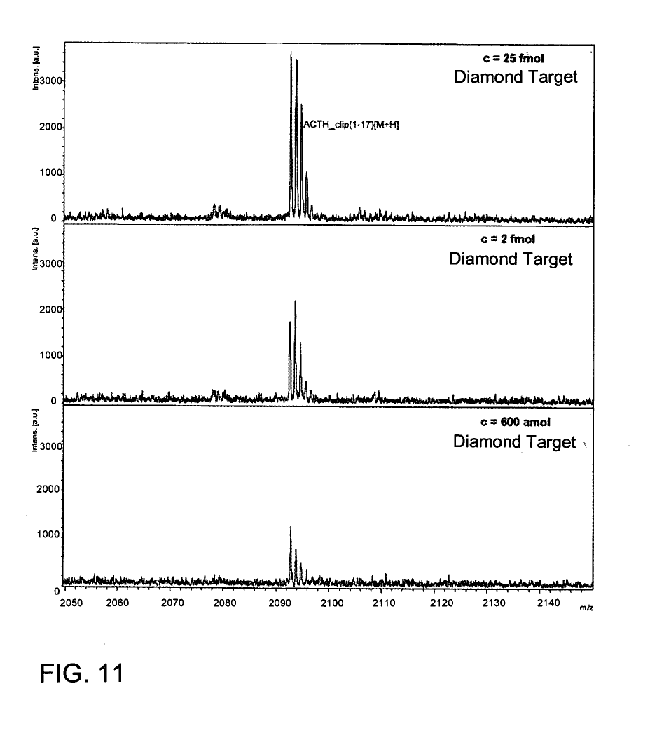

FIG. 11 depicts MS spectra of solutions containing the peptide ACTH_clip(1-17) in a series of concentrations (50 fmol/μl, 4 fmol/μl and 1200 amol/μl) with alpha-cyano-4-hydroxycinnamic acid (HCCA) as matrix substance with a target of the invention.

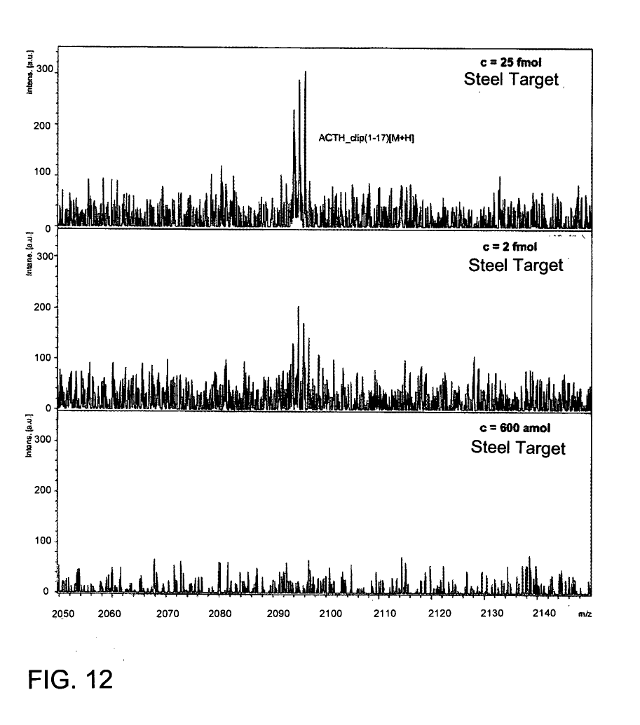

FIG. 12 depicts MS spectra of solutions containing the peptide ACTH_clip(1-17) in a series of concentrations (50 fmol/μl, 4 fmol/μl and 1200 amol/μl) with alpha-cyano-4-hydroxycinnamic acid (HCCA) as matrix substance with a conventional steel target.

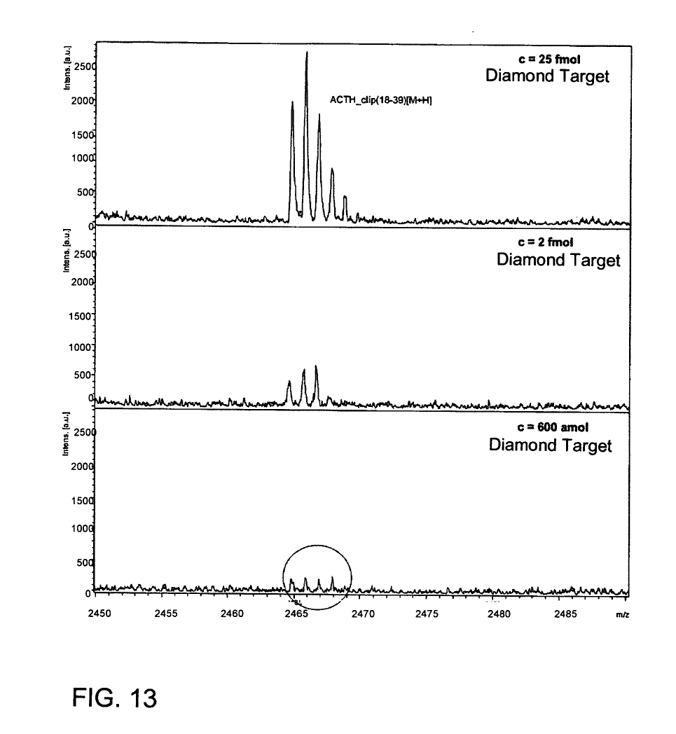

FIG. 13 depicts MS spectra of solutions containing the peptide ACTH_clip(18-39) in a series of concentrations (50 fmol/μl, 4 fmol/μl and 1200 amol/μl) with alpha-cyano-4-hydroxycinnamic acid (HCCA) as matrix substance with a target of the invention.

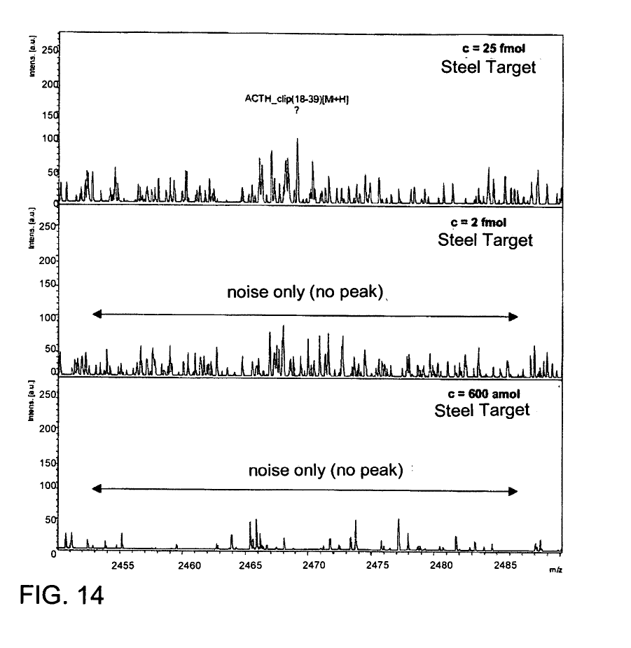

FIG. 14 depicts MS spectra of solutions containing the peptide ACTH_clip(18-39) in a series of concentrations (50 fmol/μl, 4 fmol/μl and 1200 amol/μl) with alpha-cyano-4-hydroxycinnamic acid (HCCA) as matrix substance with a conventional steel target.

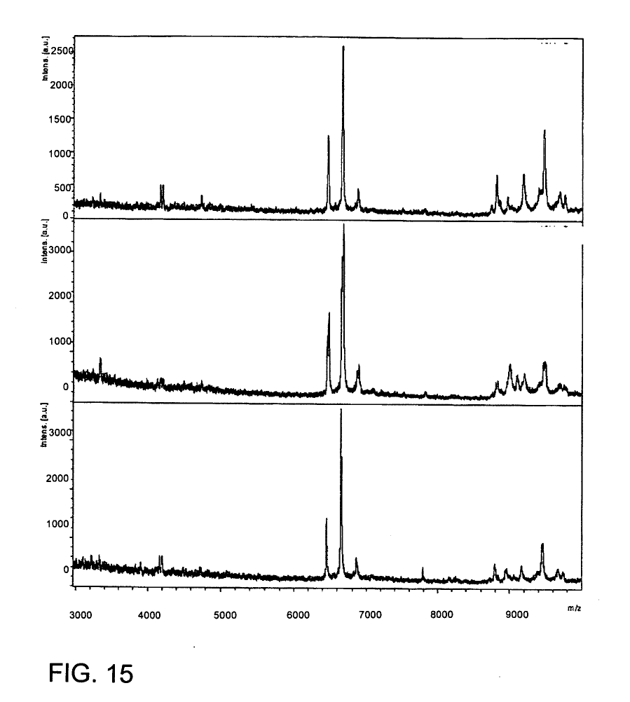

FIG. 15 depicts three mass-spectrometric analyses of human serum proteins and serum peptides in a mass range from 2-10 kDa, which were immobilized specifically to derivatized carbon nanotubes. The following conditions were applied: sinapic acid in 50% acetonitrile and 50% 0.1% TFA (trifluoroacetic acid) in deionized water; measured in positive linear mode.

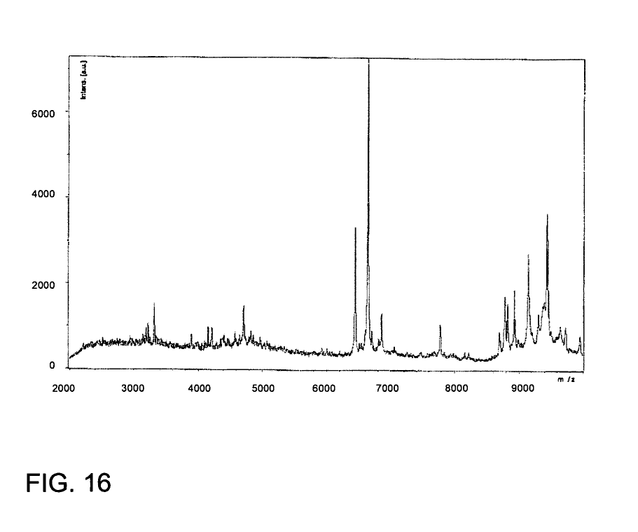

FIG. 16 depicts a mass-spectrometric analysis of human serum proteins and serum peptides in the mass range from 2-10 kDa, which were immobilized specifically to derivatized diamond beads. The following conditions were applied: sinapic acid in 50% acetonitrile and 50% 0.1% TFA in deionized water; measured in positive linear mode.

### EXAMPLES

### Example 1

### Preparation of the Diamond Layer

An appropriate substrate is purified by sonication in isopropanol for 15 minutes and subsequently dried with dry nitrogen. The part is immersed by means of a receptacle into a suspension of diamond powder (250 micrometer grain size) and isopropanol and incubated with sonication for 60 minutes. The part is then washed with isopropanol and dried with dry nitrogen.

The dried part is mounted on a substrate holder of the diamond coating device and coated with diamond for 20 hours. With a growth rate of 0.2 μm per hour, this produces a resulting layer thickness of about 4 μm.

### Example 2

### Derivatization of the Diamond Surface for Metal Affinity Chromatography

The diamond-coated substrate is placed in an illumination chamber (FIG. 3) through which nitrogen is passed. The cover (lid) of said illumination chamber consists of quartz glass.

The linker substance, for example glycidyl methacrylate, is applied to the diamond surface and the diamond-coated graphite is illuminated with UV light for 5 to 15 hours. The diamond-coated graphite is then washed with deionized water. Subsequently, the diamond-coated graphite is treated with an iminodiacetic acid solution at optimal pH for 5 to 15 hours. After washing the diamond-coated graphite with deionized water, the former is loaded with metal ions, for example copper, iron, nickel, gallium. This is followed by another washing step with deionized water (FIG. 4).

### Example 3

### Sample Preparation on the Target

40 μl of human serum, 30 μl of 8M urea, 1% CHAPS ((3-[(3-cholamidopropyl)dimethylammonio]-1-propanesulfonate) in PBS (phosphate-buffered saline) are mixed, diluted to 1:5 with PBS buffer and agitated at approx. 4° C. for 10 minutes. The diamond target derivatized with iminodiacetic acid is loaded with copper ions, activated and equilibrated with PBS buffer. After the equilibration step, 40 μl of the prepared serum are applied to the target. After a period of incubation (2 hours at 30° C.), the unbound proteins are washed away several times (preferably 3×) with PBS buffer. The washing step with PBS is followed by another washing with distilled water (1×).

### Example 4

### MALDI-TOF Analysis (FIG. 6)

After air-drying the sample on the target, matrix (preferably sinapic acid in 50% acetonitrile and 50% 0.1% TFA in water) is added. The sample is then analyzed by means of MALDI-TOF MS (Ultraflex MALDI-TOF-TOF, Bruker Daltonik, Bremen, Germany).

### Example 5

### Removal of the Sample and Regeneration of the Target (FIG. 7)

The target is first washed with deionized water and then several times with a 100 mM EDTA solution. Before drying (in a drying cabinet at 30° C.), the target is again purified with deionized water and loaded with metal ions.

### Example 6

### Testing of Detection Sensitivity

The detection sensitivity of peptides was examined in several experiments on the basis of two different sample supports (targets) by means of MALDI MS. In the first case, a mass-spectrometric target according to the invention, consisting of a nanocrystalline diamond film, was used. In the second case, a conventional stainless steel target (MTP 384 ground steel) from Bruker Daltonik (Bremen, Germany) was used for the measurement. All experiments revealed that a carbon-coated, in particular diamond-coated, mass-spectrometric target has advantages with respect to detection sensitivity which are not achieved by conventional targets according to the prior art.

The two peptides, ACTH_clip(1-17) and ACTH_clip(18-39) were analyzed by means of matrix-assisted laser desorption/ionization mass spectrometry (MALDI MS). The matrix substance used was HCCA (alpha-cyano-4-hydroxycinnamic acid). Three standard solutions containing different concentrations of the two peptides mentioned were prepared for the measurement. Solution 1 corresponded to a concentration of 50 fmol/μl, solution 2 corresponded to a concentration of 4 fmol/μl and solution 3 corresponded to a concentration of 1200 amol/μl. (Since only half a microliter is applied to the target and the concentrations of the solutions refer to one microliter, the effective, analyzed absolute amount corresponds to half the concentration value.) The sensitivity of the MALDI-TOF mass spectrometer decreases as a function of decreasing concentration of the standard solutions. In order to be able to compare the spectra, the same number of laser shots were added up in each measurement. It was demonstrated for the diamond-coated target that both ACTH_clip(1-17) and ACTH_clip(18-39) are detectable in all three standard solutions (see FIGS. 9, 11, 13). Even in the medium and low attomol range it was possible to detect the two peptides on the diamond target clearly (see FIGS. 11 and 13) and with higher intensity than on the steel target. Moreover, using the diamond target produces better resolution of the peaks and the isotopic distribution of the peptides is visible more clearly (see FIGS. 9, 11, 13). No peak signal for the peptides of the standard solutions with 4 fmol/μl and 1200 amol/μl was found any more on the steel target (see FIGS. 10, 12, 14).

Carbon-coated (in particular diamond-coated) targets prove to be very useful for research in laser-assisted mass spectrometry, owing to the high detection sensitivity of the analytes. Thus it is possible to detect even samples at extremely low concentrations. Another advantage over conventional mass-spectrometric sample supports is the inertia and robustness of the diamond-coated targets. Whereas conventional targets can be purified only with difficulty after having been loaded with samples and measured, thereby causing the analytes which remain on the target and cannot be readily removed to produce a kind of unwanted “memory effect” in the subsequent measurements, diamond-coated sample supports can be readily regenerated after analysis and the analytes can be removed completely. Previously applied analytes therefore do not influence subsequent measurements.

1-35. (canceled)

36. A target for a laser desorption/ionization mass spectrometer, comprising a substrate, wherein said substrate is at least partially coated with a carbon-containing layer comprising a material selected from the group consisting of diamond, amorphous carbon, DLC (diamond-like carbon), graphite, nanotubes, nanowires, fullerenes and mixtures thereof.

37. The target of claim 36, wherein said carbon-containing layer comprises nanocrystalline, polycrystalline, ultrananocrystalline or monocrystalline diamonds.

38. The target of claim 36, wherein said carbon-containing layer has a diamond crystallite portion of at least 10%.

39. The target of claim 37, wherein said diamonds of said carbon-containing layer have a crystallite size from about 0.1 to 500 nm.

40. The target of claim 36, wherein said carbon-containing layer has a thickness of about 0.1 nm to 50 μm.

41. The target of claim 36, wherein said carbon-containing layer is electrically conductive.

42. The target of claim 36, wherein said substrate is electrically conductive.

43. The target of claim 36, wherein said carbon-containing layer is modified to be electrically conductive.

44. The target of claim 43, wherein said modification of said carbon-containing layer is electrically conductive by interaction with adsorbed substances or doping.

45. The target of claim 36, wherein said substrate comprises a material selected from the group consisting of graphite, titanium, metal, metal oxides, mineral oxides, semiconductors, polymer, plastic, ceramics, glass, quartz glass, silica gel, steel, composite materials, nanotubes, nanowires, fullerenes and mixtures thereof.

46. The target of claim 36, wherein said carbon-containing layer has hydrophilic and hydrophobic regions.

47. The target of claim 36, wherein said carbon-containing layer is chemo-physically modified.

48. The target of claim 47, wherein said chemo-physically modified carbon-containing layer has at least one binding functionality selected from the group consisting of polar groups, apolar groups, ionic groups, groups having affinity, specific groups, metal-complexing groups and mixtures thereof.

49. The target of claim 36 wherein said carbon-containing layer further comprises a chemical modification wherein said modification includes additional substances selected from the group consisting of hydrogen atoms, halogens, halogen compounds, hydroxyl groups, carbonyl groups, aromatic ring systems, sulfur, sulfur derivatives, Grignard compounds, amino groups, epoxides, metals or carbon chains.

50. The target of claim 36 wherein said carbon-containing layer further comprises at least one binding functionality selected from the group consisting of carbon double bonds, epoxides, halogens, halogen compounds, amino groups, hydroxy groups, acid groups, acid chlorides, cyanide groups, aldehyde groups, sulfate groups, sulfonate groups, phosphate groups, metal-complexing groups, thioethers, biotin, thiolene and mixtures thereof.

51. The target of claim 36 wherein said carbon-containing layer further comprises a chemical modification with at least one linker.

52. The target of claim 51, wherein said linker comprises at least one binding functionality.

53. The target of claim 52, wherein said binding functionality is selected from the group consisting of carbon bonds, epoxides, halogens, halogen compounds, amino groups, hydroxy groups, acid groups, acid chlorides, cyanide groups, aldehyde groups, sulfate groups, sulfonate groups, phosphate groups, metal-complexing groups, thioethers, biotin, thiolene and mixtures thereof.

54. The target of claim 51, wherein said linker comprises an epoxide group selected from the group consisting of glycidyl methacrylate, 3,4-epoxybutyl acrylate, 2-methyl-2-propenyl-oxiranecarboxylic ester, methyl 3-(2-methyloxiranyl)-2-propenoate, dihydro-4-(2-propenyloxy)-2(3H)-furanone, oxiranylmethyl 2-methyl-2-propenoate, tetrahydro-3-furanyl-2-propenoic ester, oxiranylmethyl-2-butenoic ester, 1-methylethenyl-oxirane acetic ester, oxiranylmethyl-3-butenoic ester, (3-methyloxiranyl)methyl-2-propenoic ester, ethyl 3-oxiranyl-2-propenoate, 2-methyl-2-propenyl-oxirane carboxylic ester, 2-oxiranylethyl-2-propenoic ester, 3-(3-butenyl)oxirane carboxylic acid, allyl 2,3-epoxy-buttyric ester, 2,3-epoxypropyl-crotonic ester, tetrahydro-2-furanyl-2-propenoic ester, (2-methyloxiranyl)methyl-2-propenoic ester, 3-oxetanyl 2-methyl-2-propenoate, and mixtures thereof.

55. The target of claim 51, wherein said linker comprises a chemical group selected from the group consisting of iminodiacetic acid, nitrilotriacetic acid, N-carboxy-α-alanine, aspartic acid, 2-amino-2-methyl-propanedioic acid, 2-β-ranacetic acid, 5-ethyl-3-hydroxy-4-methyl-2(5H)-furanone, tetrahydro-4-methylene-3-furanacetic acid, aspartic acid, 2-butenedioic acid, methylene-propanedioic acid and mixtures thereof.

56. The target of claim 51, wherein said linker includes an amino group selected from the group consisting of 10-undecene-1-amine, 1-amino-5-hexene, N-2-propenyl-2,2,2-trifluoroacetamide and mixtures thereof.

57. The target of claim 51, wherein said linker includes a carboxylic acid group and is preferably selected from the group consisting of 2-butenedioic acid, ethylenedicarboxylic acid and mixtures thereof.

58. The target of claim 51, wherein said linker includes a halogen compound selected from the group consisting of propenyl chloride, butenyl chloride, 1-bromopropene, 1-chloropropene, 2-bromopropene, 2-chloropropene, 4-chloro-1-butene, 4-chloro-2-butene, 3-chloro-1-butene, 2-methyl-1-chloro-1-propene, 1-chloro-2-butene, 1-chloro-1-butene, 2-chloro-3-methyl-2-butene, 3-chloro-2-methyl-2-butene, 4-chloro-2-pentene, 2-chloro-2-pentene, 1-chloro-1-pentene, 1-chloro-3-methyl-1-butene, 1-chloro-2-methyl-1-butene, 3-chloro-2-pentene, 5-chloro-2-pentene, 1,5-dichloro-2-pentene, 4,4-dichloro-2-methyl-1-butene, 2-chloro-5-methyl-3-hexene, 3-chloro-4-methyl-1-hexene, 2-chloro-2-methyl-3-hexene and mixtures thereof.

59. The target of claim 36, wherein said substrate consists of graphite or titanium coated additional to said carbon-containing layer.

60. The target of claim 36, wherein said carbon-containing layer has a matrix adsorbed or covalently bound to said carbon-containing layer.

61. The target of claim 36, wherein said target has been applied in a replaceable manner to a target holder.

62. The target holder of claim 61, wherein said target holder can be placed directly into the mass spectrometer.

63. The use of a target of claim 36 for examining at least one sample by matrix-assisted laser desorption/ionization mass spectrometry or surface-enhanced laser desorption/ionization mass spectrometry.

64. A process for analyzing a sample by means of surface-enhanced laser desorption/ionization mass spectrometry, comprising:
(a) combining a sample with a target of claim 36;
(b) optionally removing the substances not bound to the target;
(c) optionally adding a matrix, embedding the sample in said matrix by means of evaporating a solvent; and
(d) analyzing said sample combined with a target by means of mass spectrometry.

65. A process for analyzing a sample by means of matrix-assisted laser desorption/ionization mass spectrometry, comprising:
(a) combining sample with a target of claim 36;
(b) optionally removing the substances not bound to the target;
(c) optionally adding a matrix, embedding the sample in said matrix by means of evaporating a solvent; and
(d) analyzing said sample combined with a target by means of mass spectrometry.

66. A carbon-containing particle or bead comprising a carbon-containing layer as defined by claim 36.

67. The use of carbon-containing particles or bead as claimed in claim 66 for selectively binding at least one analyte of a sample and for subsequently analyzing the loaded particles and/or the analytes eluted from said particle or bead by means of laser desorption/ionization mass spectrometry.

68. A carbon-containing powder comprising a carbon-containing layer material as defined by claim 36.

69. The use of a carbon-containing powder as claimed in claim 68 for selectively binding one or more analytes of a sample and subsequently analyzing the loaded powder or the analytes eluted from said powder by means of laser desorption/ionization mass spectrometry.

70. A paste-like mass comprising a carbon-containing material as defined in claim 36.

71. The use of a paste-like mass as claimed in claim 70 for binding one or more analytes of a sample and subsequently analyzing the loaded mass or the analytes eluted from said mass by means of laser desorption/ionization mass spectrometry.
